(19) United States
(12) Patent Application Publication
(10) Pub. No.: US 2010/0327535 A1
(43) Pub. Date: Dec. 30, 2010

(54) Fiber seal for ceramic matrix composite components

(75) Inventors: Christopher Grace, Indianapolis, IN (US); Mark Stewart Schroder, Greenville, SC (US); Paul Stephen Dimascio, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/659,706

(22) Filed: Mar. 17, 2010

Related U.S. Application Data
(63) Continuation of application No. 12/469,525, filed on May 20, 2009, now abandoned.
Application No. 12/469,525 is a continuation-in-part of application No. 12/010,801, filed on Jan. 30, 2008, now abandoned.
Application No. 12/010,801 is a continuation of application No. 11/374,071, filed on Mar. 14, 2006, now abandoned.
Application No. 11/374,071 is a continuation of application No. 10/801,002, filed on Mar. 16, 2004, now abandoned.

(51) Int. Cl. F16J 15/44; B32B 15/14

(52) U.S. Cl. 277/355; 428/293.1

(57) ABSTRACT

A fiber brush seal attached with metallic structure, suitable for use with SiC-SiC ceramic matrix composite (CMC) components. The fibers may be selected from oxides, carbides and nitrides of silicon, tungsten, chromium, iron, titanium, boron, zirconium and aluminum, and may optionally be coated with a boron nitride based coating.

### RELATED APPLICATIONS

The present application is a continuation-in-part of application Ser. No. 12/010,801, filed Jan. 30, 2008, abandoned, which is a continuation of application Ser. No. 11/374,071, filed Mar. 14, 2006, abandoned, which is a continuation of application Ser. No. 10/801,002, filed Mar. 16, 2004, abandoned, the entire contents of which applications are incorporated by reference in the present application.

### FIELD OF THE INVENTION

The present invention relates to a sealing device for preventing entry of deleterious gas into secondary cavities within a gas turbine. The sealing device can also be used to prevent leakage of precious coolant into the gas path or adjacent undesired secondary gas turbine cavities.

### BACKGROUND OF THE INVENTION

It is well known that sealing of hot gases and coolant flow is critical to the operational efficiency of turbo machinery. High temperature, high pressure hot gases can enter regions of turbo machinery, particularly regions composed of silicon carbide fiber composites, that cannot readily withstand the temperature regime associated with hot gases, resulting in deleterious effects on such composites and consequently on turbo machinery performance.

An approach to protecting fiber composites is to apply a protective coating to the fibers. There are two known methods for applying coatings to SiC fibers. The first is CVI (Chemical Vapor Infiltration) of a boron nitride based coating, which is applied in a vacuum furnace in the final configuration shapes shown in attached Figures. The second method is CVD (Chemical Vapor Deposition) which is applied in a plasma state deposition of a boron nitride based coating on individual fiber tows, which are then formed into the seals shown in the attached Figures.

A need exists for a way of sealing hot gas and/or coolant flow from entering or leaving secondary flow cavities in and around ceramic matrix composite components, for example'melt-infiltrated ceramic matrix composite components used in turbo machinery. The present invention seeks to meet that need.

### BRIEF DESCRIPTION OF THE INVENTION

It has now been discovered, surprisingly, according to the present invention, that it is possible to provide a sealing device for sealing hot gas and/or coolant flow from entering or leaving secondary flow cavities in and around ceramic matrix composite (CMC) components, for example melt-infiltrated ceramic matrix composite (MI-CMC) components used in turbo machinery. A MI-CMC is a high temperature multi-infiltrated matrix of silicon carbon in a structured finger lay-up of weave made of silicon carbon fibers in a component shape. More particularly, the present invention applies the brush seal concept to ceramic matrix composites by using a new brush material comprised of coated and/or uncoated fibers fabricated from carbides, oxides or nitrides of metals or non-metals. A particular non-limiting example of such fibers is silicon carbide fibers.

In one aspect, the present invention provides a brush seal made of fibers which may optionally be coated with an. oxidation-resistant boron nitride coating, wherein the fibers may be of an element selected from silicon, tungsten, chromium, iron, titanium, boron, zirconium and aluminum. The element may be present as a carbide, nitride and/or oxide.

The seal is suitable for use, for example, with CMC components, more typically with SiC-SiC MI-CMC's. A particular example is where the fibers are fabricated from the same material as the MI-CMC, most typically silicon carbide fibers.

In a further aspect, there is provides a metallic component having associated therewith fibers which may optionally be coated or otherwise isolated from detrimental wear or ionic degradation due to dissimilarity of metal and the fiber. The fibers may comprise an element selected from silicon, tungsten, chromium, iron, titanium, boron, zirconium and aluminum. The element may be present as a carbide, oxide and/or nitride.

The need for a new material (coated and/or uncoated fiber) to seal against components made of this new material (MI-CMC) results from the fact that there is an extreme degradation mechanism that exists between MI-CMC material and all metals. For example, due to the presence of corrosive combustive gases in and around CMC components fabricated from silicon carbide, a rapid ionic transfer occurs with all metallic components, which results in a continuous erosion of the silicon carbide CMC component. According to the present invention, it has been discovered surprisingly that when a brush material (such as coated and/or uncoated SiC) is employed instead of metal, having similar temperature resistance properties as the CMC component, this erosion is mitigated.

The fibers used in the seal described in the present invention may be in any one of several different forms. Thus, as examples, the fibers may be in the form of fiber tow, woven fabric, and braided strand. The invention is not limited to the particular form of the fiber.

### BRIEF DESCRIPTION OF THE DRAWINGS

FIG. 1 shows a mounting structure for a Stage 1 turbine shroud component;

FIG. 2 shows a seal arrangement in which fibers (coated or uncoated) are attached to a damper block by a metallic component;

FIG. 3 shows an alternative seal arrangement;

FIG. 4 shows another seal arrangement;

FIG. 5 shows a further seal arrangement.

### DETAILED DESCRIPTION OF THE INVENTION

In the following discussion, reference will be made to MI-CMC's. However, the present invention is not limited to melt-infiltration CMC's, and is applicable to all CMC's, regardless of their processing.

In addition, while the discussion below refers to silicon-containing fibers, for example silicon carbide, it will be understood that the invention is not limited to such fiber materials. Thus, other materials with high temperature resistance and properties may be used. Examples include oxides, carbides and nitrides of silicon, tungsten, chromium, iron, titanium, boron, zirconium and aluminum. Fibers fabricated from mullite may also be employed.

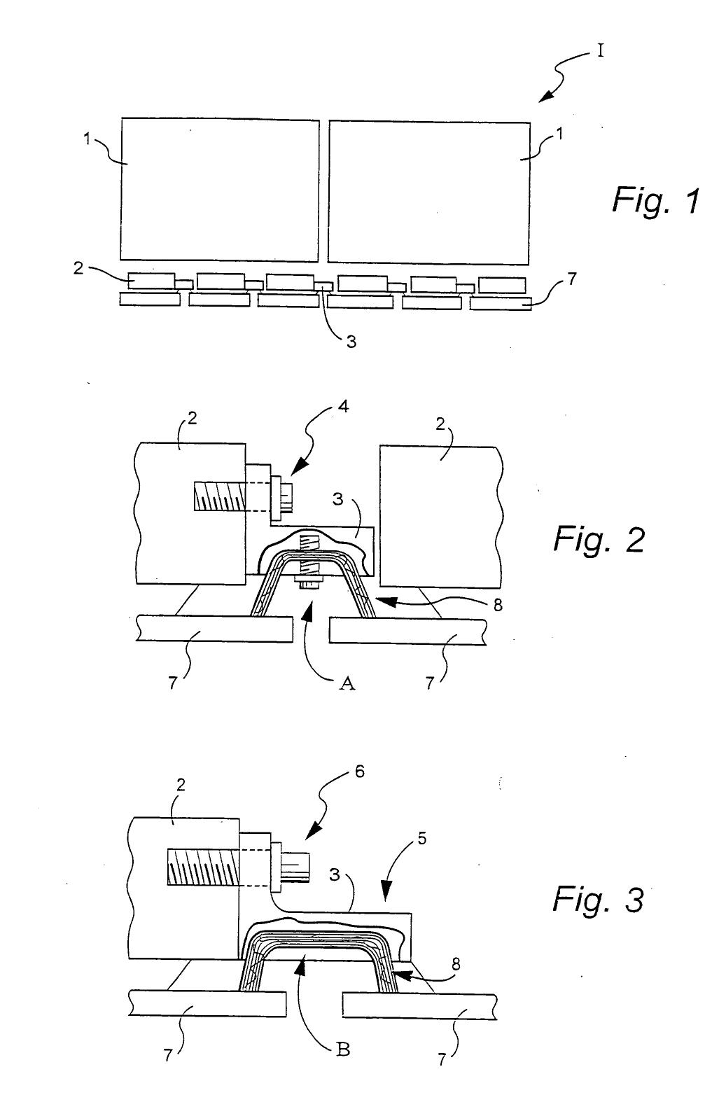

Referring to the drawings, FIG. 1 shows, generally, the sealing concept of the invention, with four options for seal attachment (described in more detail in FIGS. 2, 3, 4 and 5). In FIG. 1, a metallic mounting structure I is shown for a stage 1 turbine shroud component, including an outer shroud connected to the casing (not shown) of a turbine and an inner shroud 7 connected to the outer shroud. The outer shroud 1 is attached to a damper block 2 which acts as a loading feature and a gas path pressure pulse damping mechanism onto the inner shroud component 7. The inner shroud is made of MI-CMC material.

FIG. 2 shows silicon carbide fibers (coated and/or uncoated) 8 attached to the damper block 2 by a metallic seal attachment device 3 using a bolt 4 that is threaded and retained (typically by staking) onto the seal attachment device 3. Another high temperature bolt (A) mechanically retains the fiber seal 8 into the seal attachment device 3. The over-arch of the fiber seal E between adjacent inner shrouds 7 prevents the gas turbine hot gases that are flowing between the inner shroud 7 from entering the cavity behind the inner shroud 7 and coming into contact with the lower temperature capable metal components (1, 2, 3, 4).

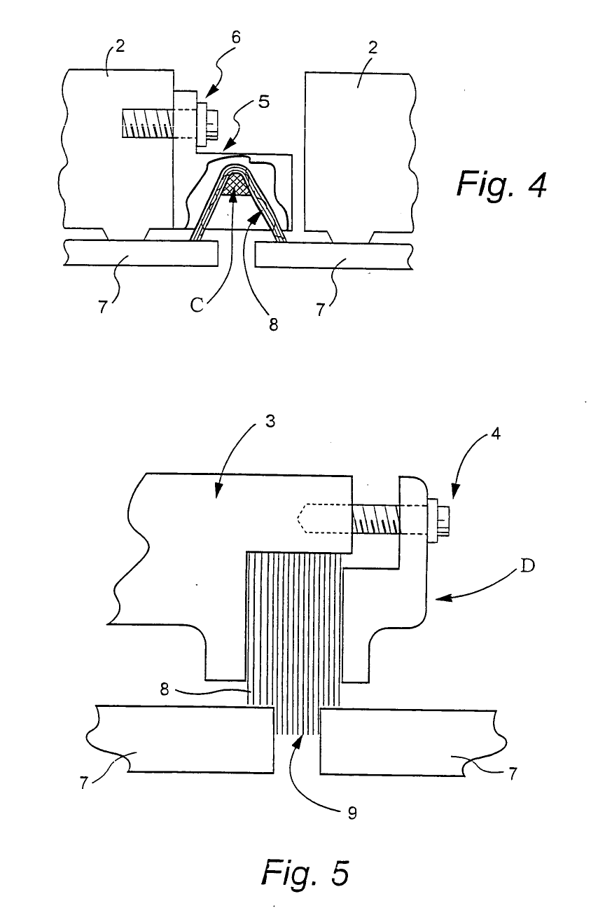

The attachment device 3 also functions to provide structural support, as well as compliance with manufacturing tolerances, shroud damping due to blade passing and loading of shroud onto the attachment, and pressure (hot gas) containment rather than seal actuation. The'device 3 in intended to cover various bonding techniques for sealing the fibers, typically silicon carbide fibers, within a metallic structure which can be mounted to turbine structure 2. Thus, in an alternative embodiment, device 3 may be configured to guide a shaped fiber packs circumferentially within grooves identified by “B” (see FIG. 3). In such an embodiment, along the circumference of device 3, sections are provided between fiber packs which provide structural support for device 3 and the fiber packs. The fiber packs are bonded in place with a silicon carbon matrix to insure full sealing within the device.

FIG. 3 shows an alternative seal attachment mechanism 5. This alternative is a bonded approach, which chemically bonds the fiber seal 8 (SiC) into the seal attachment 5, which is then mechanically attached to the damper block 2 using a bolt 6 similar to that shown in FIG. 2. The seal attachment device 5 may be fabricated from monolithic ceramic or another block of MI-CMC using minimal fibers. The seal 8 may be bonded into the attached device 5 in situ or by using any interface block B.

FIG. 4 is similar to FIG. 3 except that, in FIG. 4, dissimilar material is employed for the interface block C and the attachment device 5 which could be metal or another appropriate material.

The embodiment of FIG. 5 employs a different approach for the fiber seal 8 attached to the seal attachment device 3. This approach is very similar to conventional metal brush seal design where bristles 9 are mechanically pressed and retained by a seal holder D and a bolt 4 into the seal attachment device 3. The unique aspect of this embodiment in FIG. 5 uses fibers 9 to not only touch the inner shroud 7 on the backside, but also in between the adjacent shrouds. This further reduces the amount of hot gases that can bypass the turbine bucket and go down the area between adjacent shrouds 7. This improved sealing helps to improve gas turbine efficiency and also facilitates shroud damping mentioned above.

The basic operation of the seal of the invention is similar to conventional metallic brush seals. A unique feature of the present invention when MI-CMC components are involved is the material compatibility of SiC fibers sealing against the SiC matrix surface of the MI-CMC components.

A further unique feature relates to the method of manufacture of these SiC fibers into a mounting structure in view of the material capability (SiC versus metal) of the fibrous seal, the CMC component-sealing surface and the seal mechanism mounting structure. Careful control of silicon carbide to metal contact and/or interaction is critical in minimizing cost, and forming ease of SiC components which may be in contact with metal.

FIGS. 2-5 discussed above relate to static applications. However, the invention is not limited to static applications, and also contemplates high speed rotation sealing between static and rotating components. Many static components within combustion turbomachinery such as nozzles or diaphragms or vanes typically have sealing mechanisms on their inner diameter which is in close proximity to rotating components such as blades, buckets and/or turbines. These vital seals prevent the cooling flow intended to cool the rotating blades from. escaping into the main hot gas path flow before fulfilling their cooling objective. The alternative of hot gases leaking into the cavities between blades and vanes and causing detrimental damage to components which are not specifically designed to have high temperature hot gas path flow directly on their surfaces is clearly not desired.

The invention additionally contemplates an intra-seal (between fibers) structure, which provides support and seal integrity and would, advantageously, be placed inside the fiber pack, thereby improving sealing and structural support. FIG. 5 may represent a more complex departure from conventional static seal design since it embeds the sealing fibers directly into a cavity requiring the seal due to the necessity of material compatibility with SiC fibers sealing on SiC matrix components. This embodiment effectively traps all of the deleterious hot gases within the high temperature components which are specifically designed to accommodate the hot gases without active cooling flow. The only challenge will this embodiment rests in the relatively large about of exposed fiber surface contact with metallic components D and 3.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A silicon carbide fiber brush seal, suitable or use with ceramic matrix composite (CMC) components wherein the fiber comprises an element selected from silicon, tungsten, chromium, iron, titanium, boron, zirconium and aluminum.

2. A silicon carbide fiber brush seal, suitable for use with SiC-SiC MI-CMC components.

3. A brush seal according to claim 1, coated with a boron nitride based coating.

4. A brush seal according to claim 2, wherein said silicon carbide is in the form of fiber tow.

5. A brush seal according to claim 2 wherein said silicon carbide is in the form of woven fabric.

6. A brush seal according to claim 2 wherein said silicon carbide is in the form of braided strand.

7. A brush seal according to claim 1, wherein said element is present as a carbide, oxide and/or nitride.

8. A metallic component having associated therewith fibers which may be coated or otherwise isolated from detrimental wear or ionic degradation due to dissimilarity of metal and the fiber, wherein said fibers comprise an element selected from silicon, tungsten, chromium, iron, titanium, boron, zirconium and aluminum.

9. A metallic component according to claim 8, wherein said element is present as a carbide, oxide and/or nitride.
